(19) United States
(12) Patent Application Publication
(10) Pub. No.: US 2024/0119622 A1
(43) Pub. Date: Apr. 11, 2024

(54) OBJECT RECOGNITION METHOD OF THREE-DIMENSIONAL SPACE AND COMPUTING APPARATUS

(71) Applicant: Yu-Wei Tu, New Taipei City (TW)

(72) Inventors: Yu-Wei Tu, New Taipei City (TW); Chun-Kai Chang, New Taipei City (TW)

(73) Assignee: Yu-Wei Tu, New Taipei City (TW)

(21) Appl. No.: 18/454,076

(22) Filed: Aug. 23, 2023

Related U.S. Application Data
(60) Provisional application No. 63/413,624, filed on Oct. 6, 2022.

(30) Foreign Application Priority Data
Nov. 18, 2022 (TW) 111144155

(51) Int. Cl. G06T 7/70; G06T 7/90; G06T 17/00; H04N 23/695

(52) U.S. Cl. CPC G06T 7/70; G06T 7/90; G06T 17/00; H04N 23/695; G06T 2207/10024; G06V 2201/07

(57) ABSTRACT

An object recognition method of a three-dimensional (3D) space and a computing apparatus are provided. In the method, multiple sensing points in the 3D space are allocated to multiple areas. The 3D space is established by the sensing points generated by scanning a space. Multiple 2D images of each of the areas are captured. The 2D images of each of the areas are recognized. One or more objects in the 3D space are determined according to a recognized result of the 2D images of the areas. Accordingly, the object in the 3D space may be recognized.

### CROSS-REFERENCE TO RELATED APPLICATION

This application claims the priority benefit of the U.S. provisional application Ser. No. 63/413,624, filed on Oct. 6, 2022, and the Taiwan application serial no. 111144155, filed on Nov. 18, 2022. The entirety of each of the above-mentioned patent applications is hereby incorporated by reference herein and made a part of this specification.

### BACKGROUND

### Technical Field

The disclosure relates to an object detection technology, and more particularly, to an object recognition method of a three-dimensional (3D) space and a computing apparatus.

### Description of Related Art

To simulate a real space, the real space can be scanned to generate a simulated space that appears similar to the real space. The simulated space can be implemented in various applications such as gaming, home decoration, robot navigation, etc. It is worth noting that although two-dimensional (2D) image recognition technology has been widely adopted today, it is difficult for 2D image recognition to comprehensively understand object recognition and labeling in three-dimensional space.

### SUMMARY

In view of this, the embodiment of the disclosure provides an object recognition method of a 3d space and a computing apparatus that involves transforming the 3D space into 2D images and utilizing 2D image recognition technology to achieve object recognition in the 3D space.

The object recognition method of the 3D space in the embodiment of the disclosure includes (but not limited to) the following processes. Multiple sensing points in the 3D space are allocated to multiple areas. The 3D space is established by the sensing points generated by scanning a space. Multiple 2D images of each of the areas are captured. The 2D images of each of the areas are recognized. One or more objects in the 3D space are determined according to a recognized result of the 2D images of the areas.

The computing apparatus in the embodiment of the disclosure includes a memory and a processor. The memory is configured to store a code. The processor is coupled to the memory. The processor loads the code to execute to following process. Multiple sensing points in the 3D space are allocated to multiple areas. Multiple 2D images of each of the areas are captured. The 2D images of each of the areas are recognized. One or more objects in the 3D space are determined according to a recognized result of the 2D images of the areas. The 3D space is established by the sensing points generated by scanning a space.

Based on the above, according to the object recognition method of the 3D space and the computing apparatus in the embodiment of the disclosure, the 3D space is initially divided into multiple areas. Then, 2D images are captured from each of the areas, and the objects in the 3D space are recognized according to the recognized result of the 2D image. This contributes to the recognition and understanding of objects in 3D space.

In order to make the above-mentioned features and advantages of the disclosure comprehensible, embodiments accompanied with drawings are described in detail below.

### BRIEF DESCRIPTION OF THE DRAWINGS

FIG. 1 is a block diagram of elements of a computing apparatus according to an embodiment of the disclosure.

FIG. 2 is a flowchart of an object recognition method of a 3D space according to an embodiment of the disclosure.

FIG. 3A is a schematic view of sensing points in a 3D space according to an embodiment of the disclosure.

FIG. 3B is a schematic view of determining areas according to an embodiment of the disclosure.

FIG. 4 is a schematic view of capturing an image according to an embodiment of the disclosure.

### DESCRIPTION OF THE EMBODIMENTS

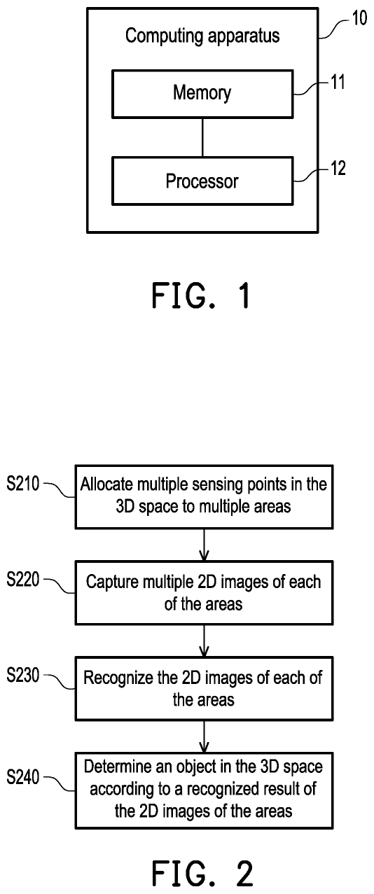

FIG. 1 is a block diagram of elements of a computing apparatus 10 according to an embodiment of the disclosure. Referring to FIG. 1, the computing apparatus 10 may be a mobile phone, a tablet computer, a desktop computer, a laptop, a server, or an intelligent assistant apparatus. The computing apparatus 10 includes (but not limited to) a memory 11 and a processor 12.

The memory 11 may be any type of fixed or movable random access memory (RAM), read only memory (ROM), flash memory, conventional hard disk drive (HDD), solid-state drive (SSD) or similar components. In one embodiment, the memory 11 is configured to store code, software module, data (e.g., sensing point, position information, color information, recognized result, or 3D model) or files, which are described in detail in subsequent embodiments.

The processor 12 is coupled to the memory 11. The processor 12 may be a central processing unit (CPU), or other programmable general-purpose or special-purpose microprocessors, a digital signal processor (DSP), a programmable controller, an application-specific integrated circuit (ASIC), other similar components, or combinations of the foregoing. In one embodiment, the processor 12 is configured to execute all or part of the operations of the computing apparatus 10, and may load and execute the code, software module, files, and/or data stored in the memory 11. In one embodiment, the processor 12 performs all or part of the operations of the embodiment of the disclosure. In some embodiments, the software modules or codes stored in the memory 11 may also be implemented by physical circuits.

In the following, the method described in the embodiment of the disclosure is explained with each element in the computing apparatus 10. Each process of the method can be adjusted according to the implementation, and is not limited to thereto.

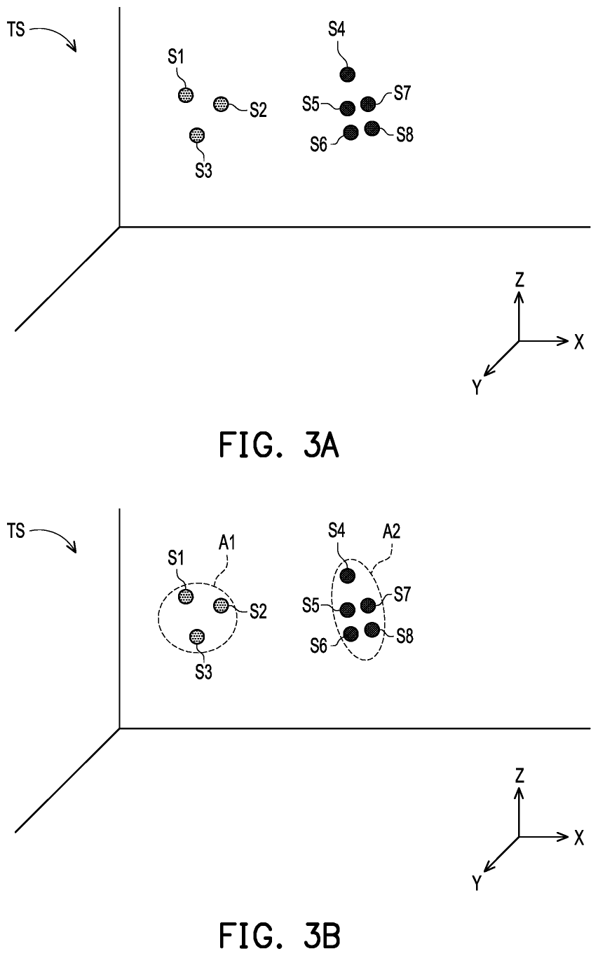

FIG. 2 is a flowchart of an object recognition method of a 3D space according to an embodiment of the disclosure. Referring to FIG. 2, the processor 12 allocates multiple sensing points in the 3D space to multiple areas (step S210). Specifically, the 3D space is established by one or more sensing points generated by scanning a (physical or virtual) space. The sensing points may reflect the existence of an object in the 3D space. For example, an optical, radar, or acoustic scanning signal is reflected by an object to generate an echo, and this echo may be used to determine the position, depth, and/or direction relative to the object. In one embodiment, the 3D space is a point cloud graph formed by the sensing points. In other embodiments, the 3D space may also be other format models. In addition, according to different application scenarios, the object may be furniture, appliances, plants, processing equipment, or decorations, or it may be a wall, ceiling, or floor, but not limited thereto.

The area allocation is used to group the sensing points. Features of the sensing points in the same group/area are similar. The features are, for example, related to position, color, or other image features (e.g., rectangle, edge, or corner). In general, the sensing points with similar features are more likely to belong to the same object.

In one embodiment, the processor 12 may group the sensing points in a multi-dimensional space according to position information in the (position) 3D space and color information in a color space of the sensing points to determine the areas. Specifically, the multi-dimensional space includes dimensions of both the 3D space and the color space. The dimension in the 3D space is, for example, three mutually perpendicular axes in the space. The dimension in the color space is, for example, RGB (red, green, and blue), CMYK (cyan, magenta, yellow, and black), or HSV (hue, saturation, and lightness).

A distance between the position information and the color information in a corresponding space between the sensing points in each of the areas is less than a distance threshold. That is, the distance threshold is used to evaluate whether the position information and/or the color information between multiple sensing points are similar. In response to the distance between the position information and the color information in the corresponding space between two sensing points being less than a distance threshold, the processor 12 may allocate these two sensing points to the same group/area. In response to the distance between the position information and the color information in the corresponding space between two sensing points not being less than a distance threshold, the processor 12 may allocate these two sensing points to different groups/areas. The position information may be the coordinates of the coordinate system corresponding to the 3D space. For example, the distance threshold is a distance of 5 cm in the 3D space. The color information may be a primary color, a standard color, or the intensity of an attribute. For example, the distance threshold may be a level-3 intensity in the color space. However, the actual value of the distance threshold is still defined according to actual needs, which is not limited by the embodiment of the disclosure.

In one embodiment, the processor 12 may utilize algorithms such as k-means algorithm, Gaussian mixture model (GMM), mean-shift algorithm, hierarchical clustering, spectral clustering algorithm, DBSCAN (density-based spatial clustering of applications with noise) algorithm, or other clustering/grouping algorithms. In addition, distance parameters (e.g., the aforementioned distance threshold or parameters related to the distance threshold) and point (or minimum number of points within a cluster/areas) parameters may be set.

For example, FIG. 3A is a schematic view of sensing points S1˜S8 in a 3D space TS according to an embodiment of the disclosure. Referring to FIG. 3A, it is assumed that the 3D space TS including eight sensing points S1˜S8 is formed after scanning a space, and the position information of the sensing points S1˜S8 may be defined by the distance relative to the X, Y, and Z axes. FIG. 3B is a schematic view of determining areas according to an embodiment of the disclosure. Referring to FIG. 3B, it is assumed that the distance of the sensing points S1˜S3 is within 5 cm and they are all black, and the distance of the sensing points S4˜S8 is within 8 cm and they are all red. Thus, the processor 12 allocates the sensing points S1˜S3 to an area A1 and the sensing points S4˜S8 to an area A2. The shape of the area is, for example, a geometric 3D shape or a concrete 3D shape formed with the center of gravity of the sensing point in the same area as the center, such as a sphere, a cube, or a football. However, the shape of the area may also be an irregular 3D shape or a shape defined by a grouping algorithm.

In other embodiments, if additional features are considered as references, it may result in a multi-dimensional space with more dimensions. In addition, the amounts and positions of the sensing points S1˜S8 shown in FIG. 3A and FIG. 3B are only for illustrative purposes only, and the amounts and positions of the sensing points still need to be determined according to actual application scenarios.

Referring to FIG. 2, the processor 12 captures multiple 2D images of each of the areas (step S220). Specifically, the processor 12 sets a virtual camera at multiple viewing positions in the 3D space and shoots towards each of the areas to capture the 2D images.

In one embodiment, the processor 12 determines a reference axis of a certain area. The reference axis is, for example, an imaginary line passing through the center of the area and perpendicular to the ground (or parallel to the direction of gravity). However, the angle of the reference axis relative to the ground may still be changed as required. The processor 12 may rotate around the area with a reference axis as the axle center and at a certain distance apart (e.g., 10, 15, or 20 centimeters, but the distance may also be dynamically adjusted based on the shape of the area) and capture multiple 2D images corresponding to multiple capturing directions in the area using the virtual camera. For example, the processor 12 defines capturing directions every 20 degrees. Thus, based on the rotation around the reference axis, a 2D image is captured through the virtual camera for every 20 degrees of rotation. However, the capturing directions may still be changed according to actual needs.

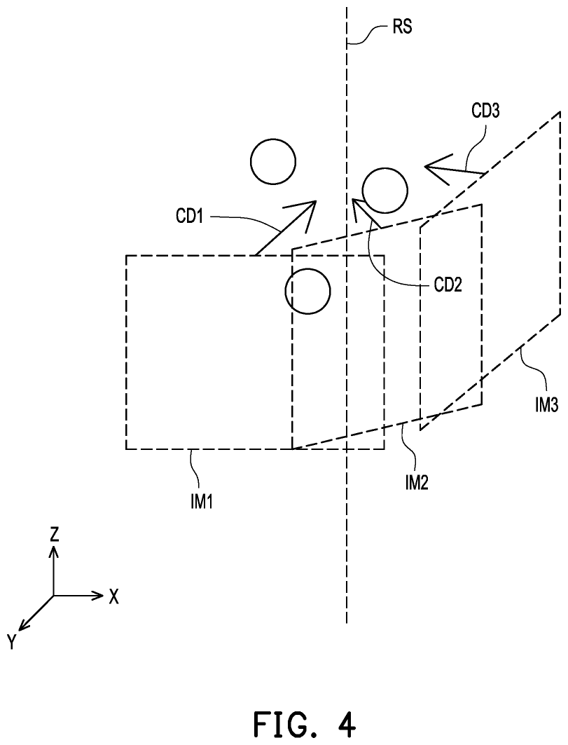

For example, FIG. 4 is a schematic view of capturing an image according to an embodiment of the disclosure. Referring to FIG. 4, according to the reference axis RS, a 2D image IM1 may be captured in a capturing direction CD1; a 2D image IM2 may be captured in a capturing direction CD2; a 2D image IM3 may be captured in a capturing direction CD3.

It should be noted that the capture of the image is not limited to capture around the axle center, and the user may determine the capturing method according to the actual needs.

Referring to FIG. 2, the processor 12 recognizes the 2D images of each of the areas (step S230). Specifically, the processor 12 may identify the type of the object in each of the 2D images based on algorithms of neural networks (e.g., YOLO (You only look once), region based convolutional neural networks (R-CNN), or Fast R-CNN) or feature-based matching algorithms (e.g., histogram of oriented gradient (HOG), scale-invariant feature transform (SIFT), Harr, or speeded up robust features (SURF)). In one embodiment, the recognized result of the 2D images includes the type of the object. In one embodiment, the recognized result of the 2D images includes probability of similarity with one or more types of the object.

Referring to FIG. 2, the processor 12 determines one or more objects in the 3D space according to a recognized result of the 2D images of the areas (step S240). Specifically, the more the recognized results of the 2D images in the same area are the same, the higher the possibility of obtaining objects of a specific object type in the area from the recognized result. In one embodiment, the processor 12 determines one or more objects located in a first area according to the recognized result of the 2D images in the capturing directions of the first area in the areas. For example, in response to the 2D images with the same recognized result exceeding a specific amount in a certain area, the processor 12 determines that this area exists as an object in the recognized result.

In addition, the more the recognized results of the 2D images in neighboring areas are the same, the higher the possibility of obtaining objects of a specific object type in these areas from the recognized result.

In an embodiment, the object obtained by the recognized result includes a first object and a second object. In response to the first object and the second object being detected in the 2D images in at least two of the capturing directions of the first area, the processor 12 may determine a probability of the first object and the second object in the first area being identical. For example, a classifier based on a neural network determines the probability of similarity between the first object and the second object, or the proportion of image features identical to a specific object. That is, in the same area, in response to the fact that more than two 2D images are detected to have two objects, the processor 12 further determines whether the two objects are identical.

The processor 12 compares the probability with a probability threshold to obtain a compared result. This probability threshold may be updated based on a machine learning algorithm. The compared result is, for example, that the probability is greater than the probability threshold, and the probability is not greater than the probability threshold.

Then, the processor 12 may determine that the first object and the second object are identical according to the compared result. In response to the probability being greater than the probability threshold, the processor 12 determines that the first object and the second object are identical. In response to the probability not being greater than the probability threshold, the processor 12 determines that the first object and the second object are not identical. For example, the processor 12 respectively detects a desktop and four table legs from four 2D images, so the processor 12 may determine that the desktop and the four table legs are identical. That is, a table.

To sum up, in the object recognition method of the 3D space and the computing apparatus in the embodiment of the disclosure, images are captured from the 3D space to obtain 2D images of different capturing directions, and the object in the 3D space is determined according to the recognized result of the 2D images. In this way, the objects in the 3D space may be recognized through 2D image recognition technology.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An object recognition method of a three-dimensional (3D) space, comprising:
allocating a plurality of sensing points in a 3D space to a plurality of areas, wherein the 3D space is established by the sensing points generated by scanning a space;
capturing a plurality of two-dimensional (2D) images of each of the areas;
recognizing the 2D images of each of the area; and
determining at least one object in the 3D space according to a recognized result of the 2D images of the areas.

2. The object recognition method of the 3D space according to claim 1, wherein allocating the sensing points in the 3D space to the areas comprises:
grouping the sensing points in a multi-dimensional space according to position information in the 3D space and color information in a color space of the sensing points to determine the areas, wherein the multi-dimensional space comprises dimensions of both the 3D space and the color space, and a distance between the position information and the color information in a corresponding space between the sensing points in each of the areas is less than a distance threshold.

3. The object recognition method of the 3D space according to claim 1, wherein capturing the 2D images of each of the areas comprises:
determining a reference axis of an area; and
rotating around the reference axis as an axle center and capturing the 2D images corresponding to a plurality of capturing directions towards the area.

4. The object recognition method of the 3D space according to claim 3, wherein determining the at least one object in the 3D space according to the recognized result of the 2D images of the areas comprises:
determining the at least one object located in a first area according to the recognized result of the 2D images in the capturing directions of the first area in the areas.

5. The object recognition method of the 3D space according to claim 4, wherein the at least one object comprises a first object and a second object, and determining the at least one object in the 3D space according to the recognized result of the 2D images of the areas comprises:
determining a probability of the first object and the second object in the first area being identical in response to the first object and the second object being detected in the 2D images in at least two of the capturing directions of the first area;
comparing the probability with a probability threshold to obtain a compared result; and
determining that the first object and the second object are identical according to the compared result.

6. A computing apparatus, comprising:
a memory, configured to store a code; and
a processor, coupled to the memory and loading the code to execute:
allocating a plurality of sensing points in a 3D space to a plurality of areas, wherein the 3D space is established by the sensing points generated by scanning a space;
capturing a plurality of two-dimensional (2D) images of each of the areas;
recognizing the 2D images of each of the areas; and
determining at least one object in the 3D space according to a recognized result of the 2D images of the areas.

7. The computing apparatus according to claim 6, wherein the processor is further used for:
grouping the sensing points in a multi-dimensional space according to position information in the 3D space and color information in a color space of the sensing points to determine the areas, wherein the multi-dimensional space comprises dimensions of both the 3D space and the color space, and a distance between the position information and the color information in a corresponding space between the sensing points in each of the areas is less than a distance threshold.

8. The computing apparatus according to claim 6, wherein the processor is further used for:
determining a reference axis of an area; and
rotating around the reference axis as an axle center and capturing the 2D images corresponding to a plurality of capturing directions towards the area.

9. The computing apparatus according to claim 8, wherein the processor is further used for:
determining the at least one object located in a first area according to the recognized result of the 2D images in the capturing directions of the first area in the areas.

10. The computing apparatus according to claim 9, wherein the at least one object comprises a first object and a second object, and the processor is further used for:
determining a probability of the first object and the second object in the first area being identical in response to the first object and the second object being detected in the 2D images in at least two of the capturing directions of the first area;
comparing the probability with a probability threshold to obtain a compared result; and
determining that the first object and the second object are identical according to the compared result.
